(19) United States
(12) Patent Application Publication
(10) Pub. No.: US 2024/0214129 A1
(43) Pub. Date: Jun. 27, 2024

(54) Method for Determining HARQ-ACK Transmission Resource, Terminal, and Storage Medium

(71) Applicant: VIVO MOBILE COMMUNICATION CO., LTD., Dongguan (CN)

(72) Inventors: Xiaohang Chen, Dongguan (CN); Chaojun Zeng, Dongguan (CN)

(21) Appl. No.: 18/432,720

(22) Filed: Feb. 5, 2024

Related U.S. Application Data
(63) Continuation of application No. PCT/CN2022/110263, filed on Aug. 4, 2022.

(30) Foreign Application Priority Data
Aug. 6, 2021 (CN) 202110903510.X

(51) Int. Cl. H04L 1/1829; H04L 5/14

(52) U.S. Cl. CPC H04L 1/1854; H04L 5/1469

(57) ABSTRACT

A method for determining a HARQ-ACK transmission resource includes determining, by a terminal, a first HARQ-ACK transmission resource based on a first subcarrier spacing and a first carrier; in a case of determining that the first HARQ-ACK transmission resource is unavailable, determining, by the terminal, a second HARQ-ACK transmission resource after a first HARQ-ACK feedback time based on the first subcarrier spacing and the first carrier, or determining a third HARQ-ACK transmission resource after the first HARQ-ACK feedback time based on a second subcarrier spacing and a second carrier, where the first HARQ-ACK feedback time is determined based on the first subcarrier spacing or based on the first subcarrier spacing and the first carrier.

### CROSS-REFERENCE TO RELATED APPLICATIONS

This application is a Bypass Continuation Application of International Patent Application No. PCT/CN2022/110263, filed Aug. 4, 2022, and claims priority to Chinese Patent Application No. 202110903510.X, filed Aug. 6, 2021, the disclosures of which are hereby incorporated by reference in their entireties.

### BACKGROUND OF THE INVENTION

### Field of the Invention

This application pertains to the field of communication technologies and specifically relates to a method for determining a hybrid automatic repeat request-acknowledgement (HARQ-ACK) transmission resource, a terminal, and a storage medium.

### Description of Related Art

In the existing HARQ-ACK transmission, when user equipment (UE) is configured with semi-persistent scheduling (SPS), a HARQ-ACK feedback time for each SPS configuration is indicated by downlink control information (DCI) for activating an SPS configuration. As a result, HARQ-ACKs corresponding to SPS physical downlink shared channels (PDSCH) for different SPS configurations may be reported at different times.

However, when a HARQ-ACK feedback time corresponding to one SPS PDSCH collides with a downlink (DL) in a time division duplex (TDD) scenario, the HARQ-ACK of the SPS PDSCH will be discarded, resulting in performance degradation of the SPS PDSCH.

### SUMMARY OF THE INVENTION

According to a first aspect, a method for determining a HARQ-ACK transmission resource is provided and applied to a terminal. The method includes:

determining, by a terminal, a first HARQ-ACK transmission resource based on a first subcarrier spacing SCS and a first carrier; and

in a case of determining that the first HARQ-ACK transmission resource is unavailable, determining, by the terminal, a second HARQ-ACK transmission resource after a first HARQ-ACK feedback time based on the first subcarrier spacing SCS and the first carrier, or determining a third HARQ-ACK transmission resource after the first HARQ-ACK feedback time based on a second subcarrier spacing SCS and a second carrier, where

the first HARQ-ACK feedback time is determined based on the first subcarrier spacing SCS or based on the first subcarrier spacing SCS and the first carrier.

According to a second aspect, an apparatus for determining a HARQ-ACK transmission resource is provided and applied to a terminal. The apparatus includes:

a first processing module, configured to determine a first HARQ-ACK transmission resource based on a first subcarrier spacing SCS and a first carrier; and

a second processing module, configured to: in a case of determining that the first HARQ-ACK transmission resource is unavailable, determine a second HARQ-ACK transmission resource after a first HARQ-ACK feedback time based on the first subcarrier spacing SCS and the first carrier, or determine a third HARQ-ACK transmission resource after the first HARQ-ACK feedback time based on a second subcarrier spacing SCS and a second carrier, where

the first HARQ-ACK feedback time is determined based on the first subcarrier spacing SCS or based on the first subcarrier spacing SCS and the first carrier.

According to a third aspect, a terminal is provided. The terminal includes a processor, a memory, and a program or instructions stored in the memory and executable on the processor, and when the program or instructions are executed by the processor, the steps of the method according to the first aspect are implemented.

According to a fourth aspect, a terminal is provided, including a processor and a communication interface, where the processor is configured to: determine a first HARQ-ACK transmission resource based on a first subcarrier spacing SCS and a first carrier; and in a case of determining that the first HARQ-ACK transmission resource is unavailable, determine a second

HARQ-ACK transmission resource after a first HARQ-ACK feedback time based on the first subcarrier spacing SCS and the first carrier, or determine a third HARQ-ACK transmission resource after the first HARQ-ACK feedback time based on a second subcarrier spacing SCS and a second carrier, where

the first HARQ-ACK feedback time is determined based on the first subcarrier spacing SCS or based on the first subcarrier spacing SCS and the first carrier.

According to a fifth aspect, a non-transitory readable storage medium is provided, where the non-transitory readable storage medium stores a program or instructions, and when the program or instructions are executed by a processor, the steps of the method according to the first aspect are implemented.

According to a sixth aspect, a chip is provided, where the chip includes a processor and a communication interface, the communication interface is coupled to the processor, and the processor is configured to run a program or instructions to implement the method according to the first aspect.

According to a seventh aspect, a computer program/program product is provided, where the computer program/program product is stored in a non-transient storage medium, and the program/program product is executed by at least one processor to implement the method for determining a HARQ-ACK transmission resource according to the first aspect.

### BRIEF DESCRIPTION OF THE DRAWINGS

FIG. 1 is a structural diagram of a wireless communication system to which embodiments of this application are applicable;

FIG. 2 is a schematic flowchart of a method for determining a HARQ-ACK transmission resource according to an embodiment of this application;

FIG. 3 is a schematic structural diagram of a carrier in a method for determining a HARQ-ACK transmission resource according to an embodiment of this application;

FIG. 4 is a schematic structural diagram of an apparatus for determining a HARQ-ACK transmission resource according to an embodiment of this application;

FIG. 5 is a schematic structural diagram of a communication device according to an embodiment of this application; and

FIG. 6 is a schematic diagram of a hardware structure of a terminal implementing an embodiment of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in the specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the contextually associated objects have an “or” relationship.

It is worth noting that the technology described in the embodiments of this application is not limited to long term evolution (LTE)/LTE-Advanced (LTE-A) systems, but may also be used in other wireless communication systems such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” are often used interchangeably in the embodiments of this application. The technologies described may be used in the above-mentioned systems and radio technologies as well as other systems and radio technologies. In the following descriptions, a new radio (NR) system is described for illustration purposes, NR terms are used in most of the following descriptions, and these technologies may also be applied to other applications than the NR system application, for example, the 6th generation (6G) communication system.

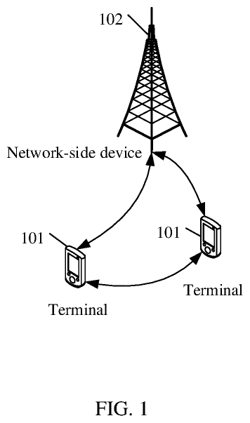

FIG. 1 is a structural diagram of a wireless communication system to which embodiments of this application are applicable. The wireless communication system includes a terminal 101 and a network-side device 102. The terminal 101 may also be referred to as a terminal device or a user terminal or user equipment (UE). The terminal 101 may be a terminal-side device, such as a mobile phone, a tablet personal computer, a laptop computer or notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicular user equipment (VUE), pedestrian user equipment (PUE), or smart-home appliance (a smart-home device with a wireless communication function, for example, a refrigerator, a television, a washing machine, or a piece of furniture). The wearable device includes a smart watch, a smart band, smart earphones, smart glasses, smart jewelry (a smart bracelet, a smart chain bracelet, a smart ring, a smart necklace, a smart anklet, a smart chain anklet, or the like), a smart wrist band, smart clothing, a game console, or the like. It should be noted that the terminal 101 is not limited to a specific type in the embodiments of this application. The network-side device 102 may be a base station or a core network. The base station may be referred to as a NodeB, an evolved NodeB, an access point, a base transceiver station (BTS), a radio base station, a radio transceiver, a basic service set (BSS), an extended service set (ESS), a home NodeB, a home evolved NodeB, a WLAN access point, a Wi-Fi node, a transmission reception point (TRP), or other appropriate terms in the art. Provided that the same technical effects are achieved, the base station is not limited to any specific technical term. It should be noted that in the embodiments of this application, only the base station in the NR system is used as an example, although the specific type of the base station is not limited.

In this embodiment of this application, the terminal may be configured to activate at least one carrier, such as carrier 1 to carrier M, where an SCS corresponding to a carrier CCₘ is SCSₘ. Assuming that among M carriers configured for the terminal, N carriers are configured with a physical uplink control channel (PUCCH) resource, N<=M, and a network has been configured to enable PUCCH carrier switching, the terminal can switch on the N carriers configured with the PUCCH resource.

Further, for the foregoing N carriers, the network may configure one or more PUCCH cell timing patterns. Each pattern indicates a PUCCH carrier available for a period of time, and different PUCCH cell timing patterns may indicate the same or different PUCCH carriers. A specific implementation for the PUCCH cell pattern may include: A time-domain pattern may be configured uniformly for these N cells or may be configured separately for each PUCCH cell.

The terminal is configured with at least one DL SPS configuration resource on carrier i, including SPS config 1 to SPS config L. It is assumed that the terminal receives a PDSCH of SPS config j at slot n. Based on k (that is, K1) indicated by DCI for activating SPS config j, a HARQ-ACK corresponding to the PDSCH is reported at slot n+k.

Since it is determined that within slot n+k, some or all of symbols occupied by a PUCCH resource for carrying a HARQ-ACK corresponding to an SPS PDSCH collide with DL symbols (for example, DL symbol, SSB, and CORESET #0), the terminal postpones the feedback of the HARQ-ACK to a subsequent time point, and the PUCCH resource for carrying the HARQ-ACK may be located on any of the foregoing N carriers configured with the PUCCH resource.

The following describes in detail a method for determining a HARQ-ACK transmission resource, a terminal, and a storage medium provided in the embodiments of this application by using some embodiments and application scenarios thereof with reference to the accompanying drawings.

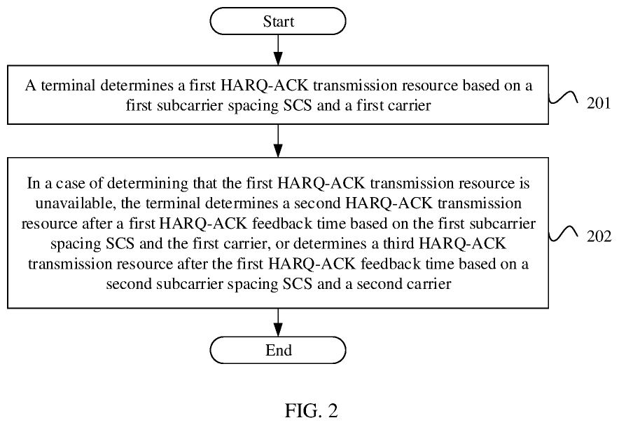

FIG. 2 is a schematic flowchart of a method for determining a HARQ-ACK transmission resource according to an embodiment of this application. The method may be executed by a terminal, and the terminal may specifically be a terminal 101 shown in FIG. 1. As shown in FIG. 2, the method includes the following steps.

Step 201. A terminal determines a first HARQ-ACK transmission resource based on a first subcarrier spacing SCS and a first carrier.

It can be understood that in a case that the terminal is configured to activate at least one carrier and each or some of the carriers have been configured with a physical uplink control channel (PUCCH), the terminal may is configured, on each carrier, with at least one DL SPS configuration resource, which may be denoted as, for example, SPS config 1 to SPS config L.

At a time-domain location, for example, slot n, when the terminal receives PDSCH signaling for the DL SPS configuration resource SPS config j, the terminal may determine any one of the carriers configured with the PUCCH and a subcarrier spacing SCS of the carrier. The carrier may be referred as a first carrier and its corresponding SCS may be referred to as a first subcarrier spacing SCS.

Then, the terminal determines a HARQ-ACK feedback time based on the first subcarrier spacing SCS and/or the first carrier to obtain a HARQ-ACK transmission resource corresponding to the HARQ-ACK feedback time. The HARQ-ACK feedback time may be referred to as a first HARQ-ACK feedback time, and the HARQ-ACK transmission resource may be referred to as a first HARQ-ACK transmission resource.

The HARQ-ACK may be a HARQ-ACK corresponding to a specific PDSCH, or may generally be a HARQ-ACK corresponding to a PDSCH that needs to report the HARQ-ACK, which may be HARQ-ACK information or a HARQ-ACK codebook such as Type 1/2/3 codebook. The PDSCH may be a dynamically scheduled PDSCH or may be an SPS PDSCH, which is not specifically limited in the embodiments of this application.

Step 202. In a case of determining that the first HARQ-ACK transmission resource is unavailable, the terminal determines a second HARQ-ACK transmission resource after a first HARQ-ACK feedback time based on the first subcarrier spacing SCS and the first carrier, or determines a third HARQ-ACK transmission resource after the first HARQ-ACK feedback time based on a second subcarrier spacing SCS and a second carrier.

The first HARQ-ACK feedback time is determined based on the first subcarrier spacing SCS or based on the first subcarrier spacing SCS and the first carrier.

It can be understood that in this embodiment of this application, on the basis that the first HARQ-ACK transmission resource is determined based on the first subcarrier spacing SCS and the first carrier, it may be further determined whether the first HARQ-ACK transmission resource is available. For example, it may be detected whether some or all of symbols occupied by the first HARQ-ACK transmission resource that is a PUCCH resource for carrying a HARQ-ACK corresponding to an SPS PDSCH within the first HARQ-ACK feedback time collide with TDD DL symbols (for example, DL symbol, SSB, and CORESET #0). In a case of collision, the first HARQ-ACK transmission resource is considered unavailable, otherwise it is considered available.

In a case that it is determined that the first HARQ-ACK transmission resource is unavailable, if PUCCH carrier switching is enabled in a network configuration, the terminal can switch on the carriers configured with the PUCCH resource. This means that feedback of a to-be-transmitted HARQ-ACK is postponed to a subsequent time point. The PUCCH resource for carrying the HARQ-ACK may be located on any of the carriers configured with the PUCCH resource.

Specifically, in a case that a carrier or PUCCH resource to be switched to is determined, another carrier other than the first carrier may be selected from the carriers configured with the PUCCH resource, an SCS corresponding to the carrier may be determined, and then another HARQ-ACK transmission resource may be determined based on the carrier and an SCS corresponding to the carrier. The another carrier may be referred to as the second carrier, the SCS corresponding to the another carrier may be referred to as the second subcarrier spacing SCS, and the HARQ-ACK transmission resource determined based on the another carrier and its corresponding SCS may be referred as the third HARQ-ACK transmission resource. It should be understood that to enable the third HARQ-ACK transmission resource to be available, the resource is determined to be after the first HARQ-ACK feedback time.

Alternatively, in a case that the first HARQ-ACK transmission resource is unavailable, the terminal may determine, based on the first subcarrier spacing SCS and the first carrier, an available HARQ-ACK transmission resource at another time-domain location corresponding to the first carrier, where the HARQ-ACK transmission resource may be referred to as the second HARQ-ACK transmission resource. It should be likewise understood that to enable the second HARQ-ACK transmission resource to be available, the resource is determined to be after the first HARQ-ACK feedback time.

Optionally, the first carrier and/or the second carrier is determined based on one of the following:

a carrier with a smallest number in carriers configured with a physical uplink control channel PUCCH resource;

a carrier with a largest number in carriers configured with a physical uplink control channel PUCCH resource;

a carrier corresponding to a current location in a physical uplink control channel PUCCH cell timing pattern;

a carrier determined according to an order of numbers of multiple carriers in a case that the first carrier and/or the second carrier corresponds to the multiple carriers;

a carrier of a semi-persistent scheduling SPS physical downlink shared channel PDSCH received by the terminal;

a carrier for uplink transmission indicated by downlink control information DCI;

a primary carrier, a primary cell (PCell) or a primary secondary cell (PScell); and

a secondary cell (SCell).

It can be understood that depending on the actual configuration of the network side, the first carrier and/or the second carrier may be determined according to any one of the various carriers listed above. The carrier corresponding to a current location in a PUCCH cell timing pattern is a carrier corresponding to a current slot in the PUCCH cell timing pattern. If there are multiple corresponding carriers in the PUCCH cell timing pattern, the carriers may be selected in an ascending (or descending) order based on their numbering. The carrier for uplink transmission indicated by the DCI includes, for example, a carrier for PUCCH transmission and/or a carrier for PUSCH transmission.

Optionally, the first subcarrier spacing SCS and/or the second subcarrier spacing SCS is determined based on one of the following:

a reference subcarrier spacing SCS configured by a network-side device;

a subcarrier spacing SCS uniformly configured by the network-side device for a cell group;

a subcarrier spacing SCS corresponding to a carrier with a smallest number in carriers configured with a physical uplink control channel PUCCH resource;

a subcarrier spacing SCS corresponding to a carrier with a largest number in carriers configured with a physical uplink control channel PUCCH resource;

a subcarrier spacing SCS of a carrier corresponding to a current location in a physical uplink control channel PUCCH cell timing pattern;

a subcarrier spacing SCS of a carrier determined according to an order (for example, an ascending order or a descending order) of numbers of multiple carriers in a case that the first carrier and/or the second carrier corresponds to the multiple carriers, or a subcarrier spacing SCS determined according to an order of subcarrier spacings SCSs of the multiple carriers;

a subcarrier spacing SCS of a carrier of a semi-persistent scheduling SPS physical downlink shared channel PDSCH received by the terminal;

a subcarrier spacing SCS of a carrier for uplink transmission indicated by downlink control information DCI;

a subcarrier spacing SCS of a primary carrier, a primary cell PCell, or a primary secondary cell PScell; and

a subcarrier spacing SCS of a secondary cell SCell.

It can be understood that the first subcarrier spacing SCS and/or the second subcarrier spacing SCS may be in a one-to-one correspondence with the optional ranges of the first carrier and/or the second carrier listed in the foregoing embodiments, including the optional ranges listed above.

It should be understood that the foregoing steps 201 and 202 may be repeated until an available HARQ-ACK transmission resource or a location corresponding to a maximum postpone time is ultimately determined from the foregoing carriers configured with the PUCCH resource. The location corresponding to the maximum postpone time may be determined based on the first subcarrier spacing SCS or the second subcarrier spacing SCS.

In the method for determining a HARQ-ACK transmission resource according to this embodiment of this application, a HARQ-ACK transmission resource is determined based on a subcarrier spacing SCS of a carrier and the carrier, and transmission of a HARQ-ACK is postponed to a subsequent available uplink resource in a case that the determined HARQ-ACK transmission resource is unavailable, which can effectively ensure reliable HARQ-ACK transmission and improve the performance of SPS PDSCH transmission.

Optionally, the determining a third HARQ-ACK transmission resource after the first HARQ-ACK feedback time based on a second subcarrier spacing SCS and a second carrier includes at least one of the following:

determining a second HARQ-ACK feedback time after the first HARQ-ACK feedback time based on the second subcarrier spacing SCS, determining the second carrier based on the second HARQ-ACK feedback time, and determining the third HARQ-ACK transmission resource based on the second HARQ-ACK feedback time and the second carrier;

determining a third HARQ-ACK feedback time based on the second subcarrier spacing SCS and the second carrier, and determining the third HARQ-ACK transmission resource based on the third HARQ-ACK feedback time and the second carrier; or

determining a fourth HARQ-ACK feedback time after the first HARQ-ACK feedback time based on the first subcarrier spacing SCS and the second subcarrier spacing SCS, and determining the third HARQ-ACK transmission resource based on the fourth HARQ-ACK feedback time and the second carrier.

It can be understood that in a case of switching to the second carrier to determine the third HARQ-ACK transmission resource, at least one of the ways listed above may be used for determining the third HARQ-ACK transmission resource based on the second subcarrier spacing SCS and the second carrier.

Specifically, similar to the case of determining the first HARQ-ACK transmission resource based on the first subcarrier spacing SCS and the first carrier, the second HARQ-ACK feedback time may be determined first based on the second subcarrier spacing SCS, where the second HARQ-ACK feedback time is after the first HARQ-ACK feedback time. Then, the second carrier is determined based on the second HARQ-ACK feedback time. Ultimately, the third HARQ-ACK transmission resource is determined based on the second HARQ-ACK feedback time and the second carrier.

Alternatively, the third HARQ-ACK feedback time may be determined first based on the second subcarrier spacing SCS and the second carrier, and the third HARQ-ACK transmission resource is then determined based on the third HARQ-ACK feedback time and the second carrier. When the third HARQ-ACK feedback time is determined based on the second subcarrier spacing SCS and the second carrier, a HARQ-ACK feedback time indication set corresponding to the second carrier may be determined first, and the set is then analyzed based on the second subcarrier spacing SCS so as to determine the third HARQ-ACK feedback time. Optionally, the third HARQ-ACK feedback time is after the first HARQ-ACK feedback time.

Alternatively, the fourth HARQ-ACK feedback time may be determined first based on the first subcarrier spacing SCS and the second subcarrier spacing SCS, and the fourth HARQ-ACK feedback time is after the first HARQ-ACK feedback time. Then, the third HARQ-ACK transmission resource is determined based on the fourth HARQ-ACK feedback time and the second carrier. For example, if it is assumed that the first subcarrier spacing SCS is u₁, the second subcarrier spacing SCS is u₂, and the first HARQ-ACK feedback time is slot x, it may be determined that the fourth HARQ-ACK feedback time is slot└x·1^{u}^{₂}^{-u}^{₁}┘+max(2^{u}^{₂}^{-u}^{₁},1).

In this embodiment of this application, a HARQ-ACK feedback time after the first HARQ-ACK feedback time is determined first, and then the third HARQ-ACK transmission resource is determined based on the HARQ-ACK feedback time and the second carrier. This can determine an available resource with reference to subcarrier spacings of different carriers, so as to ensure reliable transmission.

Optionally, a time interval between a HARQ-ACK transmission resource and a time division duplex TDD downlink DL resource is not less than a preset threshold, where the HARQ-ACK transmission resource is determined based on at least one of the second HARQ-ACK feedback time, the third HARQ-ACK feedback time, or the fourth HARQ-ACK feedback time, and the preset threshold includes a predetermined number of time units configured by a network-side device or predefined by the terminal.

It can be understood that in this embodiment of this application, when the third HARQ-ACK transmission resource is determined based on the second HARQ-ACK feedback time, the third HARQ-ACK feedback time, and the fourth HARQ-ACK feedback time that are determined in the foregoing embodiments and are after the first HARQ-ACK feedback time, a time interval between the third HARQ-ACK transmission resource and the time division duplex TDD downlink DL resource may be not less than the preset threshold. In other words, a time interval including at least L time units may be present between the determined third HARQ-ACK transmission resource and the DL resource, where L is a positive integer predefined by the terminal or configured by the network.

In this embodiment of this application, limiting the time interval between the third HARQ-ACK transmission resource and the DL resource can more quickly obtain an available third HARQ-ACK transmission resource.

Optionally, an interval between the first HARQ-ACK feedback time or a semi-persistent scheduling SPS physical downlink shared channel PDSCH and each of the second HARQ-ACK feedback time, the third HARQ-ACK feedback time, and the fourth HARQ-ACK feedback time is not greater than a first maximum postpone length, where the first maximum postpone length is determined based on the first subcarrier spacing SCS or the second subcarrier spacing SCS.

It can be understood that since the PUCCH resource is configured on limited carriers of the network side, HARQ-ACK transmission cannot be infinitely postponed. Specifically, in this embodiment of this application, a maximum postpone length may be determined based on the first subcarrier spacing SCS or the second subcarrier spacing SCS, and the interval between the first HARQ-ACK feedback time or the semi-persistent scheduling physical downlink shared channel (SPS PDSCH) and each of the second HARQ-ACK feedback time, the third

HARQ-ACK feedback time, and the fourth HARQ-ACK feedback time is limited to be not greater than the maximum postpone length, so as to keep the determined HARQ-ACK transmission resource within an available carrier range. For ease of distinction, the maximum postpone length therein may be referred to as a first maximum postpone length.

It should be understood that in this embodiment of this application, in a process of determining an available UL resource, HARQ-ACK feedback is postponed first in time dimension, to be specific, the second HARQ-ACK feedback time, the third HARQ-ACK feedback time, or the fourth HARQ-ACK feedback time is determined, and a corresponding carrier is then determined until the available UL resource or the location corresponding to the maximum postpone time is found. The location corresponding to the maximum postpone time is associated with the first maximum postpone length, both of which may be determined based on the first subcarrier spacing SCS or the second subcarrier spacing SCS.

For example, in a case that an initial location for HARQ-ACK feedback is slot y and slot y corresponds to the first subcarrier spacing SCS, it may be determined, based on the second subcarrier spacing SCS, that a location corresponding to a maximum postpone is slot└y·2^{u}^{₂}^{-u}^{₁}┘+k+K_{def}.

In a case that a reception location of the physical downlink share channel PDSCH is slot z and slot z corresponds to the first subcarrier spacing SCS, it may be determined, based on the second subcarrier spacing SCS, that a location corresponding to a maximum postpone is slot 2└z·2^{u}^{₂}^{-u}^{₁}┘+k+K_{def}.

u₁ and u₂ respectively denote the first subcarrier spacing SCS and the second subcarrier spacing SCS, K_{def} or k+K_{def} represents a maximum postpone time for a HARQ-ACK, that is, a postpone time, K_{def} may be determined based on the second subcarrier spacing SCS, and k represents a HARQ-ACK feedback time interval configured by the network.

In this embodiment of this application, limiting the time interval between the first HARQ-ACK feedback time or the SPS PDSCH and each of the second HARQ-ACK feedback time, the third HARQ-ACK feedback time, and the fourth HARQ-ACK feedback time can keep the determined HARQ-ACK transmission resource within the available carrier range.

Optionally, the determining a second HARQ-ACK feedback time after the first HARQ-ACK feedback time based on the second subcarrier spacing SCS includes: determining whether there is an available uplink resource on the first carrier within the first HARQ-ACK feedback time; in a case that there is no available uplink resource on the first carrier within the first HARQ-ACK feedback time, determining a postpone time based on the second subcarrier spacing SCS; and determining the second HARQ-ACK feedback time based on the first HARQ-ACK feedback time and the postpone time.

It can be understood that in this embodiment of this application, in the case that there is no available resource on the first carrier, the second HARQ-ACK feedback time is determined based on the second subcarrier spacing SCS. Therefore, before switching to the second carrier, the terminal detects whether there is an available resource on the first carrier after calculating the first HARQ-ACK feedback time based on the first carrier. If there is no available resource on the first carrier, the terminal determines the second HARQ-ACK feedback time after the first HARQ-ACK feedback time and switches to the second carrier to continue searching for an available resource.

For example, assuming that the first HARQ-ACK feedback time is slot j, the terminal determines an available UL resource on the first carrier at slot j. If there is no available UL resource at slot j, the terminal determines the second HARQ-ACK feedback time based on the second subcarrier spacing SCS, for example, j=j+d, where d is a postpone time predefined by the terminal or configured by the network, and d is determined based on the second subcarrier spacing SCS.

Then, the terminal may determine the second carrier based on the second HARQ-ACK feedback time and ultimately determine, based on the second HARQ-ACK feedback time and the second carrier, the available UL resource or the location corresponding to the maximum postpone time on the second carrier.

In this embodiment of this application, determining a given postpone time based on the second subcarrier spacing SCS and determining the second HARQ-ACK feedback time based on the postpone time can enable the terminal to search an available HARQ-ACK transmission resource on a same carrier without the need for carrier switching. This features higher efficiency.

The foregoing embodiments are examples for describing the embodiments of this application without limiting the protection scope of the embodiments of this application. For example, a method for determining a HARQ-ACK transmission resource according to an embodiment of this application may include the following processing steps.

(1) Determine a HARQ-ACK transmission resource based on a first SCS and a first carrier.

Optionally, a first HARQ-ACK feedback time is determined based on the first SCS, the first carrier is determined based on the first HARQ-ACK feedback time, and the HARQ-ACK transmission resource is determined based on the first HARQ-ACK feedback time and the first carrier.

Optionally, the first HARQ-ACK feedback time is determined based on a HARQ-ACK feedback time indication set (K1 set) corresponding to the first SCS.

Optionally, the first HARQ-ACK feedback time is determined based on a K1 set configured for a cell group.

Optionally, the first HARQ-ACK feedback time is determined based on the first SCS and the first carrier, and the HARQ-ACK transmission resource is determined based on the first HARQ-ACK feedback time and the first carrier.

Optionally, the first carrier is determined according to a network indication or a predefined rule.

Optionally, the first HARQ-ACK feedback time is determined based on a HARQ-ACK feedback time indication set (K1 set) corresponding to the first carrier.

Optionally, UE determines, based on the first SCS, an initial location (for example, slot n+k) for HARQ-ACK feedback, and determines a first carrier corresponding to the HARQ-ACK feedback. Specifically, k is defined based on the first SCS.

(2) In a case that no available HARQ-ACK transmission resource is determined based on the first HARQ-ACK feedback time and the first carrier, determine a HARQ-ACK transmission resource after the first HARQ-ACK feedback time based on a second SCS and a second carrier.

Optionally, a second HARQ-ACK feedback time is determined based on the second SCS, where the second HARQ-ACK feedback time is after the first HARQ-ACK feedback time; the second carrier is determined based on the second HARQ-ACK feedback time; and the HARQ-ACK transmission resource is determined based on the second HARQ-ACK feedback time and the second carrier.

Specifically, UE determines an available UL resource on the first carrier at slot j (the first HARQ-ACK feedback time); in a case of no available UL resource at slot j; determines the second HARQ-ACK feedback time based on the second SCS, for example, j=j+d (d is associated with the second SCS); determines the second carrier based on the second HARQ-ACK feedback time; and determines an available UL resource based on the second HARQ-ACK feedback time and the second carrier.

Optionally, the second HARQ-ACK feedback time is determined based on the second SCS and the second carrier, and the HARQ-ACK transmission resource is determined based on the second HARQ-ACK feedback time and the second carrier.

Specifically, the second HARQ-ACK feedback time is determined based on the second SCS and the second carrier, where the second HARQ-ACK feedback time is after the first HARQ-ACK feedback time.

Optionally, a time interval including at least L time units is present between the second HARQ-ACK feedback time and the DL resource, where L is predefined or configured by the network.

Optionally, the second HARQ-ACK feedback time is determined based on the first SCS and the second SCS, where the second HARQ-ACK feedback time is after the first HARQ-ACK feedback time. Specifically, if the first SCS is u₁, the second SCS is u₂, and the first HARQ-ACK feedback time is slot x, the second HARQ-ACK feedback time is slot└x·2^{u}^{₂}^{u}^{₁}┘+max(2^{u}^{₂}^{-u}^{₁},1).

Optionally, a time interval including at least L time units is present between the second HARQ-ACK feedback time and the DL resource, where L is predefined or configured by the network.

(3) Steps (1) and (2) are repeated until an available UL resource or a location corresponding to a maximum postpone time is determined. The location corresponding to the maximum postpone time is determined based on the first SCS or the second SCS.

Optionally, HARQ-ACK feedback is postponed first in time dimension, to be specific, the second HARQ-ACK feedback time is determined, and a corresponding carrier is then determined until the available UL resource or the location corresponding to the maximum postpone time is found.

Specifically, an initial location for HARQ-ACK feedback is slot y, an SCS corresponding to slot y is a first SCS u₁, and therefore a location corresponding to a maximum postpone time is determined as slot└y·2^{u}^{₂}^{-u}^{₁}┘+k+K_{def} based on a second SCS u₂, where K_{def} is determined based on the second SCS. K_{def} or (k+K_{def}) represents a maximum postpone time for a HARQ-ACK.

Specifically, a PDSCH reception location is slot z, an SCS corresponding to slot z is a first SCS u₁, and therefore a location corresponding to a maximum postpone time is determined as slot└z·2^{u}^{₂}^{-u}^{₁}┘+k+K_{def} based on a second SCS, where K_{def} is determined based on the second SCS. K_{def} or (k+K_{def}) represents a maximum postpone time for a HARQ-ACK.

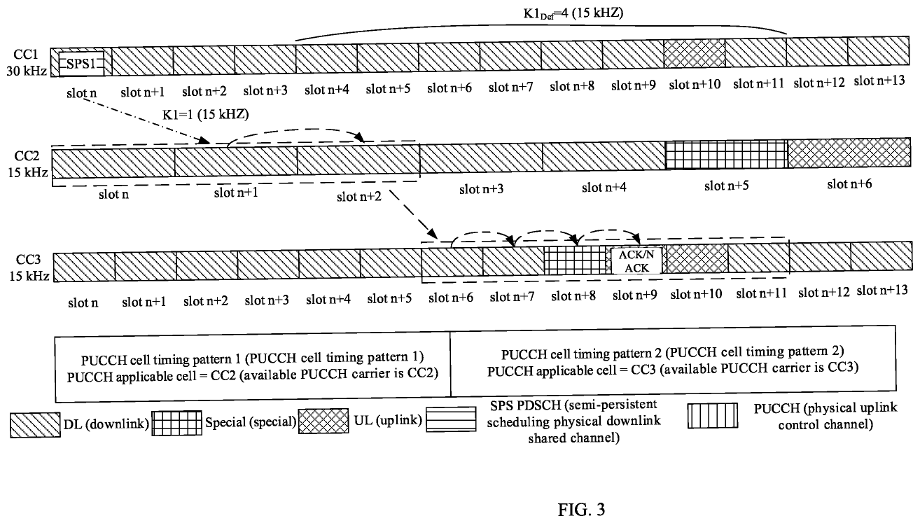

For example, FIG. 3 is a schematic structural diagram of a carrier in a method for determining a HARQ-ACK transmission resource according to an embodiment of this application. It is assumed that a network has configured PUCCH cell timing pattern 1 and PUCCH cell timing pattern 2, where an available PUCCH carrier in PUCCH cell timing pattern 1 is CC2 (15 kHz) and corresponds to slot n₂ to slot n₂+2; and an available PUCCH carrier in PUCCH cell timing pattern 2 is CC3 (30 kHz) and corresponds to slot n+6 to slot n+11.

UE receives an SPS PDSCH on CC1 (SCS=30 kHz) at a time-domain location slot n₁.

According to the foregoing embodiments, the first carrier is a carrier corresponding to PUCCH cell timing pattern 1, that is, CC2. The first SCS is a corresponding SCS of a carrier corresponding to PUCCH cell timing pattern 1. The second SCS is a corresponding SCS of a carrier corresponding to PUCCH cell timing pattern 2.

HARQ-ACK corresponding to the PDSCH obtained based on the first carrier and the first SCS is reported at slot n₂+k₁ , where k₁=1, and k₁ is defined based on SCS=15 kHz. Therefore, an initial location for HARQ-ACK feedback is slot n₂+1 with SCS=15 kHz.

Assuming that K1_{Def}=4, where K1_{Def} is defined based on SCS=15 kHz, a maximum postpone time length of a HARQ-ACK corresponding to the SPS PDSCH includes 4 slots with SCS 15 kHz. This means that the feedback of the HARQ-ACK can be postponed to slot n₂+5 at most.

The UE searches an available UL resource at slot n₂+1 on CC2. Since slot n₂+1 of the CC2 collides with DL, the UE postpones HARQ-ACK feedback to a subsequent time-domain location. Since the PUCCH cell timing pattern 1 is still applicable, the UE searches an available UL resource at slot n₂+2 on CC2. Similarly, slot n₂+2 collides with DL, the UE continues to postpone HARQ-ACK feedback to a subsequent time-domain location.

In this case, based on the PUCCH cell timing pattern 2, an available corresponding carrier is CC3. Based on the second SCS=30 kHz, an available UL resource is searched from slot n₃+6 at a step length of slot=30 kHz. Specifically, in a case of determining slot n₃+9 of the CC3 as the available UL resource, the UE utilizes it for HARQ-ACK transmission.

The foregoing processing procedures may be simplified into the following processing procedures.

(1) Determine a HARQ-ACK transmission resource based on a first SCS and a first carrier.

(2) In a case of no available HARQ-ACK transmission resource based on a first HARQ-ACK feedback time and the first carrier, determine a HARQ-ACK transmission resource after the first HARQ-ACK feedback time based on a second SCS and a second carrier.

(3) Steps (1) and (2) are repeated until an available UL resource or a location corresponding to a maximum postpone time is determined. The location corresponding to the maximum postpone time is determined based on the first SCS or the second SCS.

Optionally, that the terminal determines a second HARQ-ACK transmission resource after the first HARQ-ACK feedback time based on the first subcarrier spacing SCS and the first carrier includes at least one of the following:

a fifth HARQ-ACK feedback time after the first HARQ-ACK feedback time is determined based on the first subcarrier spacing SCS and the first carrier, and the second HARQ-ACK transmission resource is determined based on the fifth HARQ-ACK feedback time and the first carrier; or

a sixth HARQ-ACK feedback time after the first HARQ-ACK feedback time is determined based on the first subcarrier spacing SCS and the second subcarrier spacing SCS, and the second HARQ-ACK transmission resource is determined based on the sixth HARQ-ACK feedback time and the first carrier.

It can be understood that in a case that the first carrier corresponds to multiple time-domain locations, in the foregoing embodiments, at least one of the ways listed above may be used for determining the second HARQ-ACK transmission resource based on the first subcarrier spacing SCS and the first carrier.

Specifically, similar to that the first HARQ-ACK transmission resource is determined based on the first subcarrier spacing SCS and the first carrier, another HARQ-ACK feedback time may be determined first as the fifth HARQ-ACK feedback time based on the first subcarrier spacing SCS and the first carrier, and the second HARQ-ACK transmission resource is then determined based on the fifth HARQ-ACK feedback time and the first carrier. When a second HARQ-ACK feedback time is determined based on the first subcarrier spacing SCS and the first carrier, a HARQ-ACK feedback time indication set corresponding to the first carrier may be determined first, and the set is then analyzed based on the first subcarrier spacing SCS so as to determine the fifth HARQ-ACK feedback time.

Alternatively, another HARQ-ACK feedback time may be determined first as the sixth HARQ-ACK feedback time based on the first subcarrier spacing SCS and the second subcarrier spacing SCS, and the sixth HARQ-ACK feedback time is after the first HARQ-ACK feedback time. Then, the second HARQ-ACK transmission resource is determined based on the sixth HARQ-ACK feedback time and the first carrier. For example, if it is assumed that the first subcarrier spacing SCS is u₁, the second subcarrier spacing SCS is u₂, and the first HARQ-ACK feedback time is slot x, it may be determined that the sixth HARQ-ACK feedback time is slot└x·2^{u}^{₂}^{-u}^{₁}┘+max(2^{u}^{₂}^{-u}^{₁}1).

In this embodiment of this application, a HARQ-ACK feedback time after the first HARQ-ACK feedback time is determined first, and then the second HARQ-ACK transmission resource is determined based on the HARQ-ACK feedback time in combination with the first carrier. This can determine an available resource in combination with subcarrier spacings of different carriers, ensuring reliable transmission.

Optionally, a time interval between the fifth HARQ-ACK feedback time and a downlink DL resource for time division duplex TDD is not less than a preset threshold, where the preset threshold includes a predetermined number of time units configured by a network-side device or predefined by the terminal.

It can be understood that to increase the availability of the determined HARQ-ACK transmission resource, on the basis that the fifth HARQ-ACK feedback time after the first HARQ-ACK feedback time is determined, in a case that the second HARQ-ACK transmission resource is determined based on the fifth HARQ-ACK feedback time, a time interval between the second HARQ-ACK transmission resource and the downlink DL resource for time division duplex TDD may be not less than the preset threshold. In other words, a time interval including at least L time units may be present between the determined second HARQ-ACK transmission resource and the DL resource, where L is a positive integer predefined by the terminal or configured by the network.

In this embodiment of this application, limiting the time interval between the second HARQ-ACK transmission resource and the DL resource can more quickly obtain an available second HARQ-ACK transmission resource.

Optionally, an interval between the first HARQ-ACK feedback time or a semi-persistent scheduling SPS physical downlink shared channel PDSCH and each of the fifth

HARQ-ACK feedback time and the sixth HARQ-ACK feedback time is not greater than a second maximum postpone length, where the second maximum postpone length is determined based on the first subcarrier spacing SCS or the second subcarrier spacing SCS.

It can be understood that similar to that the third HARQ-ACK transmission resource is determined based on the second subcarrier spacing SCS and the second carrier, since the PUCCH resource is configured on limited carriers of the network side, HARQ-ACK transmission cannot be infinitely postponed. Specifically, in this embodiment of this application, a maximum postpone length may be determined based on the first subcarrier spacing SCS or the second subcarrier spacing SCS, and the interval between the first HARQ-ACK feedback time or the SPS PDSCH and each of the fifth HARQ-ACK feedback time and the sixth HARQ-ACK feedback time is limited to be not greater than the maximum postpone length, so as to keep the determined second HARQ-ACK transmission resource within an available carrier range. For ease of distinction, the maximum postpone length therein may be referred to as a second maximum postpone length.

In this embodiment of this application, limiting the time interval between the first HARQ-ACK feedback time or the SPS PDSCH and each of the fifth HARQ-ACK feedback time and the sixth HARQ-ACK feedback time can keep the determined HARQ-ACK transmission resource within the available carrier range.

Optionally, that the terminal determines a first HARQ-ACK transmission resource based on a first subcarrier spacing SCS and a first carrier includes one of the following:

The terminal determines the first HARQ-ACK feedback time based on the first subcarrier spacing SCS; the terminal determines the first carrier based on the first HARQ-ACK feedback time; and the terminal determines the first HARQ-ACK transmission resource based on the first HARQ-ACK feedback time and the first carrier.

The terminal determines the first HARQ-ACK feedback time based on the first subcarrier spacing SCS and the first carrier; and the terminal determines the first HARQ-ACK transmission resource based on the first HARQ-ACK feedback time and the first carrier.

It can be understood that similar to that the third HARQ-ACK transmission resource is determined based on the second subcarrier spacing SCS and the second carrier in the foregoing embodiments, at least one of the ways listed above may be used for determining the first HARQ-ACK transmission resource based on the first subcarrier spacing SCS and the first carrier.

Alternatively, a HARQ-ACK feedback time may be determined first as the first HARQ-ACK feedback time based on the first subcarrier spacing SCS. Then, the first carrier is determined based on the first HARQ-ACK feedback time. Then, based on this, a corresponding HARQ-ACK transmission resource is determined as the first HARQ-ACK transmission resource based on the first HARQ-ACK feedback time and the determined first carrier.

Alternatively, the first HARQ-ACK feedback time may be determined first based on the first subcarrier spacing SCS and the first carrier, and the first HARQ-ACK transmission resource is then determined based on the first HARQ-ACK feedback time and the first carrier. When the first HARQ-ACK feedback time is determined based on the first subcarrier spacing SCS and the first carrier, a HARQ-ACK feedback time indication set corresponding to the first carrier may be determined first, and the set is then analyzed based on the first subcarrier spacing SCS so as to determine the first HARQ-ACK feedback time.

Optionally, that the terminal determines the first HARQ-ACK feedback time based on the first subcarrier spacing SCS includes at least one of the following:

the first HARQ-ACK feedback time is determined based on a HARQ-ACK feedback time indication set corresponding to the first subcarrier spacing SCS; or

the first HARQ-ACK feedback time is determined based on a HARQ-ACK feedback time indication set configured for a cell group.

It can be understood that when the first HARQ-ACK feedback time is determined based on the first subcarrier spacing SCS, any time k can be indicated from the HARQ-ACK feedback time indication set preconfigured based on the first subcarrier spacing SCS or the HARQ-ACK feedback time indication set preconfigured for the cell group as the first HARQ-ACK feedback time.

The first subcarrier spacing SCS and the HARQ-ACK feedback time indication set may be configured based on a cell group, so the first subcarrier spacing SCS corresponds to the cell group.

In this embodiment of this application, the first HARQ-ACK feedback time is determined first, and then the first HARQ-ACK transmission resource is determined based on the

HARQ-ACK feedback time in combination with the first carrier. This can determine an available resource in combination with subcarrier spacings of different carriers, ensuring reliable transmission.

Optionally, that the terminal determines the first HARQ-ACK feedback time based on the first subcarrier spacing SCS and the first carrier includes: The terminal determines the first HARQ-ACK feedback time based on the HARQ-ACK feedback time indication set corresponding to the first carrier.

It can be understood that based on the HARQ-ACK feedback time indication set (K1 set) corresponding to the first carrier, the terminal may indicate any HARQ-ACK feedback time from the set and determine the HARQ-ACK feedback time as the first HARQ-ACK feedback time. The first carrier may be correspondingly configured with one HARQ-ACK feedback time indication set, and the first HARQ-ACK feedback time may be determined by analyzing the set based on the first subcarrier spacing SCS.

Optionally, the method for determining a HARQ-ACK transmission resource further includes: The terminal determines the first carrier according to a network-side indication or a predefined rule. It can be understood that when determining the first carrier based on the first HARQ-ACK feedback time, the terminal may specifically determine the first carrier according to a network indication or a predefined rule.

To describe the technical solutions in the embodiments of this application more clearly, the following uses examples for description without limiting the protection scope of the embodiments of this application. For example, a method for determining a HARQ-ACK transmission resource according to an embodiment of this application may include the following processing steps.

(1) Determine a HARQ-ACK transmission resource based on a first SCS and a first carrier.

Optionally, a first HARQ-ACK feedback time is determined based on the first SCS, the first carrier is determined based on the first HARQ-ACK feedback time, and the HARQ-ACK transmission resource is determined based on the first HARQ-ACK feedback time and the first carrier.

Optionally, the first HARQ-ACK feedback time is determined based on a HARQ-ACK feedback time indication set (K1 set) corresponding to the first SCS.

Optionally, the first HARQ-ACK feedback time is determined based on a K1 set configured for a cell group.

Optionally, the first HARQ-ACK feedback time is determined based on the first SCS and the first carrier, and the HARQ-ACK transmission resource is determined based on the first HARQ-ACK feedback time and the first carrier.

Optionally, the first carrier is determined according to a network indication or a predefined rule.

Optionally, the first HARQ-ACK feedback time is determined based on a HARQ-ACK feedback time indication set (K1 set) corresponding to the first carrier.

Optionally, UE determines, based on the first SCS, an initial location (for example, slot n+k) for HARQ-ACK feedback, and determines a first carrier corresponding to the HARQ-ACK feedback. Specifically, k is defined based on the first SCS.

(2) In a case of no available HARQ-ACK transmission resource based on the first HARQ-ACK feedback time and the first carrier, determine a HARQ-ACK transmission resource after the first HARQ-ACK feedback time based on the first SCS and the first carrier.

Specifically, a second HARQ-ACK feedback time is determined based on the first SCS and the first carrier, where the second HARQ-ACK feedback time is after the first HARQ-ACK feedback time.

Optionally, a time interval including at least L time units is present between the second HARQ-ACK feedback time and a DL resource, where L is predefined or configured by a network.

Optionally, the second HARQ-ACK feedback time is determined based on the first SCS and the second SCS, where the second HARQ-ACK feedback time is after the first HARQ-ACK feedback time. Specifically, if the first SCS is u₁, the second SCS is u₂, and the first HARQ-ACK feedback time is slot x, the second HARQ-ACK feedback time is slot└x·2^{u}^{₂}^{-u}^{₁}┘+max(2^{u}^{₂}^{-u}^{₁}1).

(3) Step (2) is repeated until an available UL resource or a location corresponding to a maximum postpone time is determined. The location corresponding to the maximum postpone time is determined based on the first SCS or the second SCS.

Optionally, HARQ-ACK feedback is postponed first in time dimension, that is, the second HARQ-ACK feedback time is determined, until the available UL resource or the location corresponding to the maximum postpone time is found.

Specifically, an initial location for HARQ-ACK feedback is slot y, an SCS corresponding to slot y is a first SCS u₁, it is determined, based on a second SCS u₂, that a location corresponding to a maximum postpone time is slot└y·2^{u}^{₂}^{-u}^{₁}┘+k+K_{def}, and K_{def} is determined based on the second SCS. K_{def}or k+K_{def} represents a maximum postpone time for a HARQ-ACK.

Specifically, a PDSCH reception location is slot z, an SCS corresponding to slot z is a first SCS u₁, it is determined, based on a second SCS, that a location corresponding to a maximum postpone time is slot└z·2^{u}^{₂}^{-u}^{₁}┘+k+K_{def}, and K_{def} is determined based on the second SCS. K_{def} or k+K_{def} represents a maximum postpone time for a HARQ-ACK.

(4) If there is no available UL resource on the first carrier, that is, there is no available UL resource at locations from the initial location for HARQ-ACK feedback to the location corresponding to the maximum postpone time, carrier switching is performed to select a new first carrier for performing steps (1) and (2), where the new first carrier is selected from the remaining carriers according to a predefined rule (for example, an ascending or descending order of carriers).

The foregoing processing procedures may be simplified into the following processing procedures.

(1) Determine a HARQ-ACK transmission resource based on a first SCS and a first carrier.

(2) In a case of no available HARQ-ACK transmission resource based on the first HARQ-ACK feedback time and the first carrier, determine a HARQ-ACK transmission resource after the first HARQ-ACK feedback time based on the first SCS and the first carrier.

(3) Step (2) is repeated until an available UL resource or a location corresponding to a maximum postpone time is determined. The location corresponding to the maximum postpone time is determined based on the first SCS or a second SCS.

(4) If there is no available UL resource on the first carrier, that is, there is no available UL resource at locations from an initial location for HARQ-ACK feedback to the location corresponding to the maximum postpone time, carrier switching is performed to select a new first carrier for performing steps (1) and (2), where the new first carrier is selected from the remaining carriers according to a predefined rule.

It should be noted that the foregoing embodiments of this application may be described as follows.

TDD configurations or slot formats of the carriers are configured by the network.

For the PUCCH, switchable carriers (sets) are configured by the network or predefined as all carriers configured with the PUCCH resource. For example, for the foregoing N carriers, the network may configure one or more PUCCH cell timing patterns. Each pattern pattern indicates a PUCCH carrier available for a period of time, and different PUCCH cell timing patterns may indicate the same or different PUCCH carriers.

The available UL resource indicates that there are sufficient uplink resources on the carrier or the time-domain unit for PUCCH transmission, where the PUCCH includes the corresponding HARQ-ACK of the SPS PDSCH or may include other UCI. Alternatively, the available UL resource indicates that there are sufficient uplink resources on the carrier or the time-domain unit for PUSCH transmission, where the PUSCH is a dynamically scheduled or semi-persistently configured PUSCH, and UCI (including HARQ-ACK of the SPS PDSCH) is multiplexed on the PUSCH for transmission.

Another implementation of the embodiments of this application is that the UE does not expect both the HARQ-ACK postponing mechanism and the PUCCH carrier switching functionality with different subcarrier spacings to be enabled.

The technical solutions of the embodiments of this application are extended to be also applicable to unlicensed bands.

It should be noted that the method for determining a HARQ-ACK transmission resource provided in the embodiments of this application may be performed by an apparatus for determining a HARQ-ACK transmission resource, or a control module for performing the method for determining a HARQ-ACK transmission resource in the apparatus for determining a HARQ-ACK transmission resource. In the embodiments of this application, the method for determining a HARQ-ACK transmission resource performed by the apparatus for determining a HARQ-ACK transmission resource is used as an example to describe the apparatus for determining a HARQ-ACK transmission resource provided in the embodiments of this application.

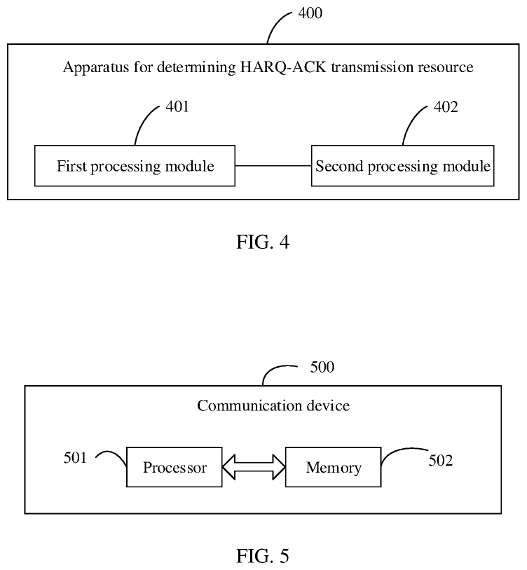

FIG. 4 is a schematic structural diagram of an apparatus for determining a HARQ-ACK transmission resource according to an embodiment of this application. The apparatus 400 may be configured to determine the HARQ-ACK transmission resource in the method for determining a HARQ-ACK transmission resource in the foregoing embodiments. The apparatus includes a first processing module 401 and a second processing module 402.

The first processing module 401 is configured to determine a first HARQ-ACK transmission resource based on a first subcarrier spacing SCS and a first carrier. The second processing module 402 is configured to: in a case of determining that the first HARQ-ACK transmission resource is unavailable, determine a second HARQ-ACK transmission resource after a first HARQ-ACK feedback time based on the first subcarrier spacing SCS and the first carrier, or determine a third HARQ-ACK transmission resource after the first HARQ-ACK feedback time based on a second subcarrier spacing SCS and a second carrier.

The first HARQ-ACK feedback time is determined based on the first subcarrier spacing SCS or based on the first subcarrier spacing SCS and the first carrier.

The apparatus for determining a HARQ-ACK transmission resource provided in this embodiment of this application determines a HARQ-ACK transmission resource based on a subcarrier spacing SCS of a carrier and the carrier, and postpones transmission of a HARQ-ACK to a subsequent available uplink resource in a case that the determined HARQ-ACK transmission resource is unavailable, which can effectively ensure reliable HARQ-ACK transmission and improve the performance of SPS PDSCH transmission.

Optionally, in a case of determining a third HARQ-ACK transmission resource after the first HARQ-ACK feedback time based on a second subcarrier spacing SCS and a second carrier, the second processing module is configured to perform at least one of the following:

determining a second HARQ-ACK feedback time after the first HARQ-ACK feedback time based on the second subcarrier spacing SCS, determining the second carrier based on the second HARQ-ACK feedback time, and determining the third HARQ-ACK transmission resource based on the second HARQ-ACK feedback time and the second carrier;

determining a third HARQ-ACK feedback time based on the second subcarrier spacing SCS and the second carrier, and determining the third HARQ-ACK transmission resource based on the third HARQ-ACK feedback time and the second carrier; or

determining a fourth HARQ-ACK feedback time after the first HARQ-ACK feedback time based on the first subcarrier spacing SCS and the second subcarrier spacing SCS, and determining the third HARQ-ACK transmission resource based on the fourth HARQ-ACK feedback time and the second carrier.

In this embodiment of this application, a HARQ-ACK feedback time after the first HARQ-ACK feedback time is determined first, and then the third HARQ-ACK transmission resource is determined based on the HARQ-ACK feedback time in combination with the second carrier. This can determine an available resource in combination with subcarrier spacings of different carriers, ensuring reliable transmission.

Optionally, in a case of determining a second HARQ-ACK feedback time after the first HARQ-ACK feedback time based on the second subcarrier spacing SCS, the second processing module is configured to:

determine whether there is an available uplink resource on the first carrier within the first HARQ-ACK feedback time;

in a case that there is no available uplink resource on the first carrier within the first HARQ-ACK feedback time, determine a postpone time based on the second subcarrier spacing SCS; and

determining the second HARQ-ACK feedback time based on the first HARQ-ACK feedback time and the postpone time.

In this embodiment of this application, determining a given postpone time based on the second subcarrier spacing SCS and determining the second HARQ-ACK feedback time based on the postpone time can enable a terminal to search an available HARQ-ACK transmission resource on a same carrier without the need for carrier hopping. This features higher efficiency.

Optionally, the third HARQ-ACK feedback time is after the first HARQ-ACK feedback time.

Optionally, a time interval between a HARQ-ACK transmission resource and a downlink DL resource for time division duplex TDD is not less than a preset threshold, where the HARQ-ACK transmission resource is determined based on at least one of the second HARQ-ACK feedback time, the third HARQ-ACK feedback time, or the fourth HARQ-ACK feedback time, and the preset threshold includes a predetermined number of time units configured by a network-side device or predefined by the terminal.

In this embodiment of this application, limiting the time interval between the third HARQ-ACK transmission resource and the DL resource can more quickly obtain an available third HARQ-ACK transmission resource.

Optionally, an interval between the first HARQ-ACK feedback time or a semi-persistent scheduling SPS physical downlink shared channel PDSCH and each of the second HARQ-ACK feedback time, the third HARQ-ACK feedback time, and the fourth HARQ-ACK feedback time is not greater than a first maximum postpone length.

The first maximum postpone length is determined based on the first subcarrier spacing SCS or the second subcarrier spacing SCS.

In this embodiment of this application, limiting the time interval between the first HARQ-ACK feedback time or the SPS PDSCH and each of the second HARQ-ACK feedback time, the third HARQ-ACK feedback time, and the fourth HARQ-ACK feedback time can keep the determined HARQ-ACK transmission resource within an available carrier range.

Optionally, in a case of determining a second HARQ-ACK transmission resource after a first HARQ-ACK feedback time based on the first subcarrier spacing SCS and the first carrier, the second processing module is configured to perform at least one of the following:

determining a fifth HARQ-ACK feedback time after the first HARQ-ACK feedback time based on the first subcarrier spacing SCS and the first carrier, and determining the second HARQ-ACK transmission resource based on the fifth HARQ-ACK feedback time and the first carrier; or

determining a sixth HARQ-ACK feedback time after the first HARQ-ACK feedback time based on the first subcarrier spacing SCS and the second subcarrier spacing SCS, and determining the second HARQ-ACK transmission resource based on the sixth HARQ-ACK feedback time and the first carrier.

In this embodiment of this application, a HARQ-ACK feedback time after the first HARQ-ACK feedback time is determined first, and then the second HARQ-ACK transmission resource is determined based on the HARQ-ACK feedback time in combination with the first carrier. This can determine an available resource in combination with subcarrier spacings of different carriers, ensuring reliable transmission.

Optionally, a time interval between the fifth HARQ-ACK feedback time and a downlink DL resource for time division duplex TDD is not less than a preset threshold, where the preset threshold includes a predetermined number of time units configured by a network-side device or predefined by the terminal.

In this embodiment of this application, limiting the time interval between the second HARQ-ACK transmission resource and the DL resource can more quickly obtain an available second HARQ-ACK transmission resource.

Optionally, an interval between the first HARQ-ACK feedback time or a semi-persistent scheduling SPS physical downlink shared channel PDSCH and each of the fifth HARQ-ACK feedback time and the sixth HARQ-ACK feedback time is not greater than a second maximum postpone length.

The second maximum postpone length is determined based on the first subcarrier spacing SCS or the second subcarrier spacing SCS.

In this embodiment of this application, limiting the time interval between the first HARQ-ACK feedback time or the SPS PDSCH and each of the fifth HARQ-ACK feedback time and the sixth HARQ-ACK feedback time can keep the determined HARQ-ACK transmission resource within an available carrier range.

Optionally, in a case of determining a first HARQ-ACK transmission resource based on a first subcarrier spacing SCS and a first carrier, the first processing module is configured to perform one of the following:

determining the first HARQ-ACK feedback time based on the first subcarrier spacing SCS, determining the first carrier based on the first HARQ-ACK feedback time, and determining the first HARQ-ACK transmission resource based on the first HARQ-ACK feedback time and the first carrier; and

determining the first HARQ-ACK feedback time based on the first subcarrier spacing SCS and the first carrier, and determining the first HARQ-ACK transmission resource based on the first HARQ-ACK feedback time and the first carrier.

In this embodiment of this application, the first HARQ-ACK feedback time is determined first, and then the first HARQ-ACK transmission resource is determined based on the HARQ-ACK feedback time in combination with the first carrier. This can determine an available resource in combination with subcarrier spacings of different carriers, ensuring reliable transmission.

Optionally, in a case of determining the first HARQ-ACK feedback time based on the first subcarrier spacing SCS, the first processing module is configured to perform at least one of the following:

determining the first HARQ-ACK feedback time based on a HARQ-ACK feedback time indication set corresponding to the first subcarrier spacing SCS; or

determining the first HARQ-ACK feedback time based on a HARQ-ACK feedback time indication set configured for a cell group.

Optionally, in a case of determining the first HARQ-ACK feedback time based on the first subcarrier spacing SCS and the first carrier, the first processing module is configured to:

determine the first HARQ-ACK feedback time based on a HARQ-ACK feedback time indication set corresponding to the first carrier.

Optionally, the apparatus further includes a third processing module configured to determine the first carrier according to a network-side indication or a predefined rule.

Optionally, the first carrier and/or the second carrier is determined based on one of the following:

a carrier with a smallest number in carriers configured with a physical uplink control channel PUCCH resource;

a carrier with a largest number in carriers configured with a physical uplink control channel PUCCH resource;

a carrier corresponding to a current location in a physical uplink control channel PUCCH cell timing pattern;

a carrier determined according to an order of numbers of multiple carriers in a case that the first carrier and/or the second carrier corresponds to the multiple carriers;

a carrier of a semi-persistent scheduling SPS physical downlink shared channel PDSCH received by the terminal;

a carrier for uplink transmission indicated by downlink control information DCI;

a primary carrier, a primary cell PCell, or a primary secondary cell PScell; and

a secondary cell SCell.

Optionally, the first subcarrier spacing SCS and/or the second subcarrier spacing SCS is determined based on one of the following:

a reference subcarrier spacing SCS configured by a network-side device;

a subcarrier spacing SCS uniformly configured by the network-side device for a cell group;

a subcarrier spacing SCS corresponding to a carrier with a smallest number in carriers configured with a physical uplink control channel PUCCH resource;

a subcarrier spacing SCS corresponding to a carrier with a largest number in carriers configured with a physical uplink control channel PUCCH resource;

a subcarrier spacing SCS of a carrier corresponding to a current location in a physical uplink control channel PUCCH cell timing pattern;

a subcarrier spacing SCS of a carrier determined according to an order of numbers of multiple carriers in a case that the first carrier and/or the second carrier corresponds to the multiple carriers, or a subcarrier spacing SCS determined according to an order of subcarrier spacings SCSs of the multiple carriers;

a subcarrier spacing SCS of a carrier of a semi-persistent scheduling SPS physical downlink shared channel PDSCH received by the terminal;

a subcarrier spacing SCS of a carrier for uplink transmission indicated by downlink control information DCI;

a subcarrier spacing SCS of a primary carrier, a primary cell PCell, or a primary secondary cell PScell; and

a subcarrier spacing SCS of a secondary cell SCell.

The apparatus for determining a HARQ-ACK transmission resource in this embodiment of this application may be an apparatus or an apparatus or electronic device having an operating system, or may be a component, an integrated circuit, or a chip in a terminal. The apparatus or electronic device may be a mobile terminal or a non-mobile terminal. For example, the mobile terminal may include but is not limited to the types of the terminal 101 listed above, and the non-mobile terminal may be a server, a network attached storage (NAS), a personal computer (PC), a television (TV), a teller machine, a self-service machine, or the like, which are not specifically limited in this embodiment of this application.

The apparatus for determining a HARQ-ACK transmission resource provided in this embodiment of this application is capable of implementing processes that are implemented by the method embodiments of FIG. 2 and FIG. 3, with the same technical effects achieved. To avoid repetition, details are not described herein again.

Optionally, as shown in FIG. 5, an embodiment of this application further provides a communication device 500 including a processor 501, a memory 502, and a program or instructions stored on the memory 502 and executable on the processor 501. For example, in a case that the communication device is a terminal, when the program or instructions are executed by the processor 501, the processes of the method for determining a HARQ-ACK transmission resource in the foregoing embodiments can be implemented, with the same technical effects achieved. To avoid repetition, details are not described herein again.

An embodiment of this application further provides a terminal. The terminal includes a processor and a communication interface. The processor is configured to: determine a first HARQ-ACK transmission resource based on a first subcarrier spacing SCS and a first carrier; in a case of determining that the first HARQ-ACK transmission resource is unavailable, determine a second HARQ-ACK transmission resource after a first HARQ-ACK feedback time based on the first subcarrier spacing SCS and the first carrier, or determine a third HARQ-ACK transmission resource after the first HARQ-ACK feedback time based on a second subcarrier spacing SCS and a second carrier, where the first HARQ-ACK feedback time is determined based on the first subcarrier spacing SCS or based on the first subcarrier spacing SCS and the first carrier. This terminal embodiment corresponds to the foregoing method embodiment on the terminal side. All processes and implementations in the foregoing method embodiments can be applicable to this terminal embodiment, with the same technical effects achieved.

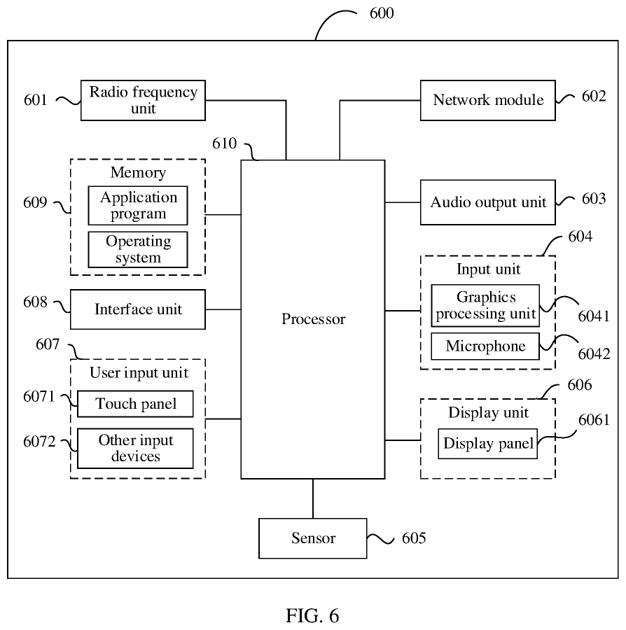

Specifically, FIG. 6 is a schematic diagram of a hardware structure of a terminal for implementing an embodiment of this application. The terminal 600 includes but is not limited to at least some of components such as a radio frequency unit 601, a network module 602, an audio output unit 603, an input unit 604, a sensor 605, a display unit 606, a user input unit 607, an interface unit 608, a memory 609, and a processor 610.

It can be understood by those skilled in the art that the terminal 600 may further include a power supply (for example, a battery) supplying power to the components. The power supply may be logically connected to the processor 610 via a power management system, so that functions such as charge management, discharge management, and power consumption management are implemented by using the power management system. The structure of the terminal shown in FIG. 6 does not constitute any limitation on the terminal, and the terminal may include more or fewer components than shown in the figure, or combine some of the components, or have different arrangements of the components. Details are not described herein.

It should be understood that in this embodiment of this application, the input unit 604 may include a graphics processing unit (GPU) 6041 and a microphone 6042. The graphics processing unit 6041 processes image data of a static picture or a video that is obtained by an image capture apparatus (for example, a camera) in a video capture mode or an image capture mode. The display unit 606 may include a display panel 6061. The display panel 6061 may be configured in a form of a liquid crystal display, an organic light-emitting diode display, or the like. The user input unit 607 includes a touch panel 6071 and other input devices 6072. The touch panel 6071 is also referred to as a touchscreen. The touch panel 6071 may include two parts: a touch detection apparatus and a touch controller. The other input devices 6072 may include but are not limited to a physical keyboard, a functional button (such as a volume control button or a power on/off button), a trackball, a mouse, and a joystick. Details are not described herein.

In this embodiment of this application, the radio frequency unit 601 transmits downlink data received from a network-side device to the processor 610 for processing, and in addition, transmits uplink data to the network-side device. Generally, the radio frequency unit 601 includes but is not limited to an antenna, at least one amplifier, a transceiver, a coupler, a low noise amplifier, and a duplexer.

The memory 609 may be configured to store software programs or instructions and various data. The memory 609 may include a program or instruction storage area and a data storage area. The program or instruction storage area may store an operating system, an application program or instructions required by at least one function (for example, sound play function or image play function), and the like. In addition, the memory 609 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage device, flash memory device, or other non-volatile solid-state storage device.

The processor 610 may include one or more processing units. Optionally, the processor 610 may integrate an application processor and a modem processor. The application processor mainly processes an operating system, a user interface, application programs or instructions, and the like. The modem processor mainly processes wireless communication, for example, being a baseband processor. It can be understood that the modem processor may alternatively be not integrated in the processor 610.

The processor 610 is configured to: determine a first HARQ-ACK transmission resource based on a first subcarrier spacing SCS and a first carrier; and in a case of determining that the first HARQ-ACK transmission resource is unavailable, determine a second HARQ-ACK transmission resource after a first HARQ-ACK feedback time based on the first subcarrier spacing SCS and the first carrier, or determine a third HARQ-ACK transmission resource after the first HARQ-ACK feedback time based on a second subcarrier spacing SCS and a second carrier.

The first HARQ-ACK feedback time is determined based on the first subcarrier spacing SCS or based on the first subcarrier spacing SCS and the first carrier.

The terminal provided in this embodiment of this application determines a HARQ-ACK transmission resource based on a subcarrier spacing SCS of a carrier and the carrier, and postpones transmission of a HARQ-ACK to a subsequent available uplink resource in a case that the determined HARQ-ACK transmission resource is unavailable, which can effectively ensure reliable HARQ-ACK transmission and improve the performance of SPS PDSCH transmission.

Optionally, the processor 610 is further configured to perform at least one of the following:

determining a second HARQ-ACK feedback time after the first HARQ-ACK feedback time based on the second subcarrier spacing SCS, determining the second carrier based on the second HARQ-ACK feedback time, and determining the third HARQ-ACK transmission resource based on the second HARQ-ACK feedback time and the second carrier;

determining a third HARQ-ACK feedback time based on the second subcarrier spacing SCS and the second carrier, and determining the third HARQ-ACK transmission resource based on the third HARQ-ACK feedback time and the second carrier; or

determining a fourth HARQ-ACK feedback time after the first HARQ-ACK feedback time based on the first subcarrier spacing SCS and the second subcarrier spacing SCS, and determining the third HARQ-ACK transmission resource based on the fourth HARQ-ACK feedback time and the second carrier.

In this embodiment of this application, a HARQ-ACK feedback time after the first HARQ-ACK feedback time is determined first, and then the third HARQ-ACK transmission resource is determined based on the HARQ-ACK feedback time in combination with the second carrier. This can determine an available resource in combination with subcarrier spacings of different carriers, ensuring reliable transmission.

Optionally, the processor 610 is further configured to:

determine whether there is an available uplink resource on the first carrier within the first HARQ-ACK feedback time;

in a case that there is no available uplink resource on the first carrier within the first HARQ-ACK feedback time, determine a postpone time based on the second subcarrier spacing SCS; and

determine the second HARQ-ACK feedback time based on the first HARQ-ACK feedback time and the postpone time.

In this embodiment of this application, determining a given postpone time based on the second subcarrier spacing SCS and determining the second HARQ-ACK feedback time based on the postpone time can enable the terminal to search an available HARQ-ACK transmission resource on a same carrier without the need for carrier hopping. This features higher efficiency.

Optionally, the processor 610 is further configured to perform at least one of the following:

determining a fifth HARQ-ACK feedback time after the first HARQ-ACK feedback time based on the first subcarrier spacing SCS and the first carrier, and determining the second HARQ-ACK transmission resource based on the fifth HARQ-ACK feedback time and the first carrier; or

determining a sixth HARQ-ACK feedback time after the first HARQ-ACK feedback time based on the first subcarrier spacing SCS and the second subcarrier spacing SCS, and determining the second HARQ-ACK transmission resource based on the sixth HARQ-ACK feedback time and the first carrier.

In this embodiment of this application, a HARQ-ACK feedback time after the first HARQ-ACK feedback time is determined first, and then the second HARQ-ACK transmission resource is determined based on the HARQ-ACK feedback time in combination with the first carrier. This can determine an available resource in combination with subcarrier spacings of different carriers, ensuring reliable transmission.

Optionally, the processor 610 is further configured to perform one of the following:

determining the first HARQ-ACK feedback time based on the first subcarrier spacing SCS, determining the first carrier based on the first HARQ-ACK feedback time, and determining the first HARQ-ACK transmission resource based on the first HARQ-ACK feedback time and the first carrier; and

determining the first HARQ-ACK feedback time based on the first subcarrier spacing SCS and the first carrier, and determining the first HARQ-ACK transmission resource based on the first HARQ-ACK feedback time and the first carrier.

In this embodiment of this application, the first HARQ-ACK feedback time is determined first, and then the first HARQ-ACK transmission resource is determined based on the HARQ-ACK feedback time in combination with the first carrier. This can determine an available resource in combination with subcarrier spacings of different carriers, ensuring reliable transmission.

Optionally, the processor 610 is further configured to perform at least one of the following:

determining the first HARQ-ACK feedback time based on a HARQ-ACK feedback time indication set corresponding to the first subcarrier spacing SCS; or

determining the first HARQ-ACK feedback time based on a HARQ-ACK feedback time indication set configured for a cell group.

Optionally, the processor 610 is further configured to determine the first HARQ-ACK feedback time based on a HARQ-ACK feedback time indication set corresponding to the first carrier.

Optionally, the processor 610 is further configured to determine the first carrier according to a network-side indication or a predefined rule.

An embodiment of this application further provides a non-transitory readable storage medium, where the non-transitory readable storage medium stores a program or instructions, and when the program or instructions are executed by a processor, the processes of the method for determining a HARQ-ACK transmission resource in the foregoing embodiments are implemented, with the same technical effects achieved. To avoid repetition, details are not described herein again.

The processor is a processor in the terminal described in the foregoing embodiment. The non-transitory readable storage medium includes a non-transitory computer-readable storage medium, for example, a computer read-only memory ROM), a random access memory (RAM), a magnetic disk, or an optical disc.

An embodiment of this application further provides a chip. The chip includes a processor and a communication interface. The communication interface is coupled to the processor. The processor is configured to run a program or instructions to implement the processes of the method for determining a HARQ-ACK transmission resource in the foregoing embodiments, with the same technical effect achieved. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program/program product. The computer program/program product is stored in a non-volatile storage medium, and when the program/program product is executed by at least one processor, the processes of the method for determining a HARQ-ACK transmission resource in the foregoing embodiments are implemented, with the same technical effects achieved. To avoid repetition, details are not described herein again.

It should be noted that in this specification, the terms “include”, “comprise”, or any of their variants are intended to cover a non-exclusive inclusion, such that a process, method, article, or apparatus that includes a series of elements includes not only those elements but also other elements that are not expressly listed, or further includes elements inherent to such process, method, article, or apparatus. Without more constraints, an element preceded by “includes a . . . ” does not preclude the presence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

By means of the foregoing description of the implementations, persons skilled in the art may clearly understand that the method in the foregoing embodiments may be implemented by software with a necessary general hardware platform. Certainly, the method in the foregoing embodiments may alternatively be implemented by hardware. However, in many cases, the former is a preferred implementation. Based on such an understanding, the technical solutions of this application essentially, or the part contributing to the prior art may be implemented in a form of a software product. The computer software product is stored in a storage medium (for example, a ROM/RAM, a magnetic disk, or an optical disc), and includes several instructions for instructing a terminal (which may be a mobile phone, a computer, a server, a network device, or the like) to perform the method described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A method for determining a HARQ-ACK transmission resource, comprising:
determining, by a terminal, a first HARQ-ACK transmission resource based on a first subcarrier spacing (SCS) and a first carrier; and
in a case of determining that the first HARQ-ACK transmission resource is unavailable, determining, by the terminal, a second HARQ-ACK transmission resource after a first HARQ-ACK feedback time based on the first subcarrier spacing and the first carrier, or determining a third HARQ-ACK transmission resource after the first HARQ-ACK feedback time based on a second subcarrier spacing and a second carrier, wherein
the first HARQ-ACK feedback time is determined based on the first subcarrier spacing or based on the first subcarrier spacing and the first carrier.

2. The method for determining a HARQ-ACK transmission resource according to claim 1, wherein the determining a third HARQ-ACK transmission resource after the first HARQ-ACK feedback time based on a second subcarrier spacing and a second carrier comprises at least one of the following:
determining a second HARQ-ACK feedback time after the first HARQ-ACK feedback time based on the second subcarrier spacing, determining the second carrier based on the second HARQ-ACK feedback time, and determining the third HARQ-ACK transmission resource based on the second HARQ-ACK feedback time and the second carrier;
determining a third HARQ-ACK feedback time based on the second subcarrier spacing and the second carrier, and determining the third HARQ-ACK transmission resource based on the third HARQ-ACK feedback time and the second carrier; or
determining a fourth HARQ-ACK feedback time after the first HARQ-ACK feedback time based on the first subcarrier spacing and the second subcarrier spacing, and
determining the third HARQ-ACK transmission resource based on the fourth HARQ-ACK feedback time and the second carrier.

3. The method for determining a HARQ-ACK transmission resource according to claim 2, wherein the determining a second HARQ-ACK feedback time after the first HARQ-ACK feedback time based on the second subcarrier spacing comprises:
determining whether there is an available uplink resource on the first carrier within the first HARQ-ACK feedback time;
in a case that there is no available uplink resource on the first carrier within the first HARQ-ACK feedback time, determining a postpone time based on the second subcarrier spacing; and
determining the second HARQ-ACK feedback time based on the first HARQ-ACK feedback time and the postpone time.

4. The method for determining a HARQ-ACK transmission resource according to claim 2, wherein the third HARQ-ACK feedback time is after the first HARQ-ACK feedback time.

5. The method for determining a HARQ-ACK transmission resource according to claim 2, wherein a time interval between a HARQ-ACK transmission resource and a downlink (DL) resource for time division duplex (TDD) is not less than a preset threshold, wherein the HARQ-ACK transmission resource is determined based on at least one of the second HARQ-ACK feedback time, the third HARQ-ACK feedback time, or the fourth HARQ-ACK feedback time, and the preset threshold comprises a predetermined number of time units configured by a network-side device or predefined by the terminal.

6. The method for determining a HARQ-ACK transmission resource according to claim 2, wherein an interval between the first HARQ-ACK feedback time or a semi-persistent scheduling SPS physical downlink shared channel PDSCH and each of the second HARQ-ACK feedback time, the third HARQ-ACK feedback time, and the fourth HARQ-ACK feedback time is not greater than a first maximum postpone length, wherein
the first maximum postpone length is determined based on the first subcarrier spacing or the second subcarrier spacing.

7. The method for determining a HARQ-ACK transmission resource according to claim 1, wherein the determining, by the terminal, a second HARQ-ACK transmission resource after a first HARQ-ACK feedback time based on the first subcarrier spacing and the first carrier comprises at least one of the following:
determining a fifth HARQ-ACK feedback time after the first HARQ-ACK feedback time based on the first subcarrier spacing and the first carrier, and determining the second HARQ-ACK transmission resource based on the fifth HARQ-ACK feedback time and the first carrier; or
determining a sixth HARQ-ACK feedback time after the first HARQ-ACK feedback time based on the first subcarrier spacing and the second subcarrier spacing, and determining the second HARQ-ACK transmission resource based on the sixth HARQ-ACK feedback time and the first carrier.

8. The method for determining a HARQ-ACK transmission resource according to claim 7, wherein a time interval between the fifth HARQ-ACK feedback time and a downlink (DL) resource for time division duplex (TDD) is not less than a preset threshold, wherein the preset threshold comprises a predetermined number of time units configured by a network-side device or predefined by the terminal.

9. The method for determining a HARQ-ACK transmission resource according to claim 7, wherein an interval between the first HARQ-ACK feedback time or a semi-persistent scheduling SPS physical downlink shared channel (PDSCH) and each of the fifth HARQ-ACK feedback time and the sixth HARQ-ACK feedback time is not greater than a second maximum postpone length, wherein
the second maximum postpone length is determined based on the first subcarrier spacing or the second subcarrier spacing.

10. The method for determining a HARQ-ACK transmission resource according to claim 1, wherein the determining, by a terminal, a first HARQ-ACK transmission resource based on a first subcarrier spacing and a first carrier comprises one of the following:
determining, by the terminal, the first HARQ-ACK feedback time based on the first subcarrier spacing; determining, by the terminal, the first carrier based on the first HARQ-ACK feedback time; and determining, by the terminal, the first HARQ-ACK transmission resource based on the first HARQ-ACK feedback time and the first carrier; and
determining, by the terminal, the first HARQ-ACK feedback time based on the first subcarrier spacing and the first carrier; and determining, by the terminal, the first HARQ-ACK transmission resource based on the first HARQ-ACK feedback time and the first carrier.

11. The method for determining a HARQ-ACK transmission resource according to claim 10, wherein the determining, by the terminal, the first HARQ-ACK feedback time based on the first subcarrier spacing comprises at least one of the following:
determining the first HARQ-ACK feedback time based on a HARQ-ACK feedback time indication set corresponding to the first subcarrier spacing; or
determining the first HARQ-ACK feedback time based on a HARQ-ACK feedback time indication set configured for a cell group.

12. The method for determining a HARQ-ACK transmission resource according to claim 10, wherein the determining, by the terminal, the first HARQ-ACK feedback time based on the first subcarrier spacing and the first carrier comprises:
determining, by the terminal, the first HARQ-ACK feedback time based on a HARQ-ACK feedback time indication set corresponding to the first carrier.

13. The method for determining a HARQ-ACK transmission resource according to claim 12, wherein the method further comprises:
determining, by the terminal, the first carrier according to a network-side indication or a predefined rule.

14. The method for determining a HARQ-ACK transmission resource according to claim 1, wherein the first carrier and/or the second carrier is determined based on one of the following:
a carrier with a smallest number in carriers configured with a physical uplink control channel (PUCCH) resource;
a carrier with a largest number in carriers configured with a PUCCH resource;
a carrier corresponding to a current location in a PUCCH cell timing pattern;
a carrier determined according to an order of numbers of multiple carriers in a case that the first carrier and/or the second carrier corresponds to the multiple carriers;
a carrier of a semi-persistent scheduling SPS physical downlink shared channel (PDSCH) received by the terminal;
a carrier for uplink transmission indicated by downlink control information (DCI);
a primary carrier, a primary cell (PCell), or a primary secondary cell (PScell); and
a secondary cell (SCell).

15. The method for determining a HARQ-ACK transmission resource according to claim 1, wherein the first subcarrier spacing and/or the second subcarrier spacing is determined based on one of the following:
a reference subcarrier spacing configured by a network-side device;
a subcarrier spacing uniformly configured by the network-side device for a cell group;
a subcarrier spacing corresponding to a carrier with a smallest number in carriers configured with a physical uplink control channel (PUCCH) resource;
a subcarrier spacing corresponding to a carrier with a largest number in carriers configured with a PUCCH resource;
a subcarrier spacing of a carrier corresponding to a current location in a PUCCH cell timing pattern;
a subcarrier spacing of a carrier determined according to an order of numbers of multiple carriers in a case that the first carrier and/or the second carrier corresponds to the multiple carriers, or a subcarrier spacing determined according to an order of subcarrier spacings of the multiple carriers;
a subcarrier spacing of a carrier of a semi-persistent scheduling (SPS) physical downlink shared channel (PDSCH) received by the terminal;
a subcarrier spacing of a carrier for uplink transmission indicated by downlink control information (DCI);
a subcarrier spacing of a primary carrier, a primary cell (PCell), or a primary secondary cell (PScell); and
a subcarrier spacing of a secondary cell (SCell).

16. A terminal, comprising a processor, a memory, and a program or instructions stored in the memory and executable on the processor, wherein the program or the instructions, when executed by the processor, cause the terminal to perform:
determining a first HARQ-ACK transmission resource based on a first subcarrier spacing (SCS) and a first carrier; and
in a case of determining that the first HARQ-ACK transmission resource is unavailable, determining a second HARQ-ACK transmission resource after a first HARQ-ACK feedback time based on the first subcarrier spacing and the first carrier, or determining a third HARQ-ACK transmission resource after the first HARQ-ACK feedback time based on a second subcarrier spacing and a second carrier, wherein
the first HARQ-ACK feedback time is determined based on the first subcarrier spacing or based on the first subcarrier spacing and the first carrier.

17. The terminal according to claim 16, wherein the program or the instructions, when executed by the processor, cause the terminal to perform at least one of the following:
determining a second HARQ-ACK feedback time after the first HARQ-ACK feedback time based on the second subcarrier spacing, determining the second carrier based on the second HARQ-ACK feedback time, and determining the third HARQ-ACK transmission resource based on the second HARQ-ACK feedback time and the second carrier;
determining a third HARQ-ACK feedback time based on the second subcarrier spacing and the second carrier, and determining the third HARQ-ACK transmission resource based on the third HARQ-ACK feedback time and the second carrier; or
determining a fourth HARQ-ACK feedback time after the first HARQ-ACK feedback time based on the first subcarrier spacing and the second subcarrier spacing, and
determining the third HARQ-ACK transmission resource based on the fourth HARQ-ACK feedback time and the second carrier.

18. The terminal according to claim 16, wherein the program or the instructions, when executed by the processor, cause the terminal to perform at least one of the following:
determining a fifth HARQ-ACK feedback time after the first HARQ-ACK feedback time based on the first subcarrier spacing and the first carrier, and determining the second HARQ-ACK transmission resource based on the fifth HARQ-ACK feedback time and the first carrier; or
determining a sixth HARQ-ACK feedback time after the first HARQ-ACK feedback time based on the first subcarrier spacing and the second subcarrier spacing, and determining the second HARQ-ACK transmission resource based on the sixth HARQ-ACK feedback time and the first carrier.

19. The terminal according to claim 16, wherein the program or the instructions, when executed by the processor, cause the terminal to perform at least one of the following:
determining the first HARQ-ACK feedback time based on the first subcarrier spacing; determining the first carrier based on the first HARQ-ACK feedback time; and determining the first HARQ-ACK transmission resource based on the first HARQ-ACK feedback time and the first carrier; and
determining the first HARQ-ACK feedback time based on the first subcarrier spacing and the first carrier; and determining the first HARQ-ACK transmission resource based on the first HARQ-ACK feedback time and the first carrier.

20. A non-transitory readable storage medium, wherein the non-transitory readable storage medium stores a program or instructions, and the program or the instructions, when executed by a processor of a terminal, cause the terminal to perform:
determining a first HARQ-ACK transmission resource based on a first subcarrier spacing (SCS) and a first carrier; and
in a case of determining that the first HARQ-ACK transmission resource is unavailable, determining a second HARQ-ACK transmission resource after a first HARQ-ACK feedback time based on the first subcarrier spacing and the first carrier, or determining a third HARQ-ACK transmission resource after the first HARQ-ACK feedback time based on a second subcarrier spacing and a second carrier, wherein
the first HARQ-ACK feedback time is determined based on the first subcarrier spacing or based on the first subcarrier spacing and the first carrier.
